(19) United States
(12) Patent Application Publication
(10) Pub. No.: US 2005/0261870 A1
(43) Pub. Date: Nov. 24, 2005

(54) Penetration-depth-determining device

(76) Inventors: Christoph Cramer, Aichtal (DE); Simon Gansel, Dettenhausen (DE)

Correspondence Address: STRIKER, STRIKER & STENBY, 103 EAST NECK ROAD, HUNTINGTON, NY, 11743, US

(21) Appl. No.: 11/131,995

(22) Filed: May 18, 2005

(30) Foreign Application Priority Data
May 21, 2004 (DE) 10 2004024990.3

(51) Int. Cl. G06F 15/00

(52) U.S. Cl. 702/166

(57) ABSTRACT

The invention is based on a penetration-depth-determining device, having a measurement unit (10), for determining a penetration depth of a tool (12) of a power tool (14) into a workpiece (16). It is proposed that the measurement unit (10) is intended for contactless measurement of a distance (D) from the workpiece (16).

### BACKGROUND OF THE INVENTION

The invention is based on a penetration-depth-determining device.

It has already been proposed that a power tool, in particular a drilling machine and/or a power drill, be equipped with a penetration-depth-determining device that is intended for determining a penetration depth of a tool of the power tool into a workpiece. Typically, the penetration-depth-determining device is embodied as a depth stop with a longitudinal scale. For determining or limiting the penetration depth, the tool and the depth stop are made to contact the workpiece, and with the aid of the length scale a distance of the power tool from the workpiece is determined. Next, the depth stop is displaced counter to a penetration direction by a set-point penetration depth. To that end, the set-point penetration depth is subtracted from the distance ascertained, and the result is set with the aid of the length scale. During one operation, the power tool moves in the working direction with the depth stop until the depth stop, on reaching the set-point penetration depth, touches the workpiece.

### SUMMARY OF THE INVENTION

The invention is based on a penetration-depth-determining device, having a measurement unit, for determining a penetration depth of a tool of a power tool into a workpiece.

It is proposed that the measurement unit is intended for contactless measurement of a distance from the workpiece. As a result, it can be attained that a penetration depth of the tool into the workpiece can be determined especially conveniently. Displacing the penetration-depth-determining device as a function of a dimension of the tool, such as a length of a drill fastened in place, can advantageously be dispensed with.

The term “intended” is to be understood in this connection as “designed” and “equipped” as well. In principle, the means of attaining the object of the invention can be used in conjunction with all power tools that appear appropriate to one skilled in the art and that penetrate a material of a workpiece. However, because of the attainable increase in convenience, its use in conjunction with hand-guided power tools is especially advantageous. Because of the wide variation in the dimensions of the tools that can be used, its use in conjunction with drilling machines or power drills and/or chisel hammers is especially advantageous.

Especially precise work with the power tool can be attained if the penetration-depth-determining device includes a means for setting a set-point penetration depth. Especially convenient setting of the set-point penetration depth can be achieved if the means includes a rotary knob.

If the penetration-depth-determining device includes a signal unit that is intended for tripping a signal when the distance reaches a settable value, then the reaching of the value, in particular the set-point penetration depth, can be made especially clearly apparent to a user. The signal may be an acoustical signal, an optical signal, an electronic control signal, or some other signal that appears appropriate to one skilled in the art.

If the penetration-depth-determining device has a display unit which is intended for displaying a variable that is dependent on the detected distance, then the variable can be read off especially conveniently. The variable can particularly advantageously represent the penetration depth.

Measurement of the distance of the power tool from the workpiece in a way that is at least extensively independent of the material can be attained if the measurement unit is embodied as an optical measurement unit. Especially reliable distance measurement is attainable if the measurement unit is intended for detecting a reflection angle. For blanking out a background, the measurement unit may be embodied as a light scanner, with a light source embodied as an LED or as a laser diode and with a light sensor.

However, still other embodiments of the invention are conceivable that are based on some other distance measuring method that appears appropriate to one skilled in the art. For instance, it is conceivable to use acoustical sensors, inductive or capacitive proximity sensors, and radar sensors.

In a further feature of the invention, it is proposed that the penetration-depth-determining device includes a means for adjusting the measurement unit. As a result, precise determination of the penetration depth can be attained even when used in conjunction with tools that have different dimensions. Especially advantageously, the means can be intended for determining a zero point of a distance measurement of the measurement unit.

### BRIEF DESCRIPTION OF THE DRAWINGS

FIG. 1 is a top view of a power drill with a penetration-depth-determining device;

FIG. 2 shows an alternative penetration-depth-determining device, which is integrated with a handle that is mounted on a power drill;

FIG. 3 shows the handle of FIG. 2 in a top view; and

FIG. 4 shows an alternative power drill with an integrated penetration-depth-determining device.

### DETAILED DESCRIPTION OF THE PREFERRED EMBODIMENTS

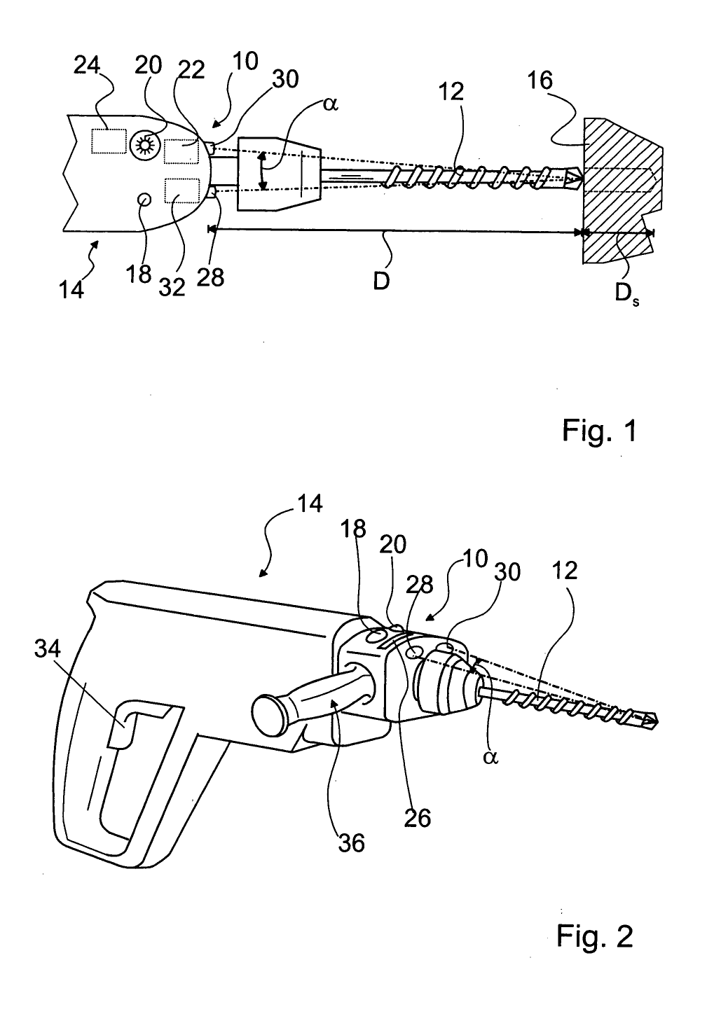

FIG. 1 shows a power tool 14, embodied as a power drill, with an integrated penetration-depth-determining device, for determining a penetration depth of a tool 12, embodied as a drill, of the power tool 14 into a workpiece 16. The penetration-depth-determining device includes a measurement unit 10, which in turn includes an LED 28 and a light sensor unit 30, and which is intended for contactless measurement of a distance D of the power tool 14 into the workpiece 16.

The measurement unit 10 is embodied as an optical measurement unit, specifically as a light scanner, which is designed for detecting a reflection angle α. To that end, the light sensor unit 30 includes at least two sensors for sensing light that has been emitted by the LED 28 and reflected back from the workpiece 16. The ratio of the light intensities detected by the two sensors of the light sensor unit 30 is determined by the reflection angle α of the sensed proportion of light at the workpiece 16. The reflection angle α is determined by the distance D of the measurement unit 10, or power tool 14, from the workpiece 16. A calibration unit 32 calibrates the signals of the light sensor unit 30 in such a way that an output signal is proportional to the distance D.

On an upper side of a housing of the power tool 14, there is a means 18, embodied as a button, for adjusting the measurement unit 10. If a user presses on the means 18, a zero point of the distance measurement, stored in memory in the calibration unit 32, is shifted in the negative direction by the distance D currently detected, so that a further measurement of the distance D without any intervening motion of the power tool 14 would produce the result zero.

A second means 20, embodied as a rotary knob, is intended for setting a set-point penetration depth Dₛ. To that end, a scale is placed on the means 20 embodied as a rotary knob, and with the aid of this scale, by turning the knob, the user can determine the set-point penetration depth Dₛ.

The penetration-depth-determining device furthermore includes a signal unit 22, which is intended for tripping a signal if the distance D attains a settable value, specifically and in particular if the distance D is less than or equal to the negative value of the set-point penetration depth Dₛ. If so, the signal deactivates the power tool 14 by interrupting a supply current. If the detected distance D is greater than or equal to the negative set-point penetration depth Dₛ, the user can reactivate the power tool 14 by means of a control button 34 that is otherwise blocked.

During a drilling operation, the user proceeds as follows to determine the penetration depth, or the depth of the drilled hole: First, with the power tool 14 at a stop, he puts the tool 12 in contact with the workpiece 16. He then adjusts the measurement unit 10 by pressing on the means 18 and sets the set-point penetration depth Dₛ of the tool 12 into the workpiece 16 by rotating the means 20. These last two steps can be omitted, if the user has already performed them during a previous drilling operation. Finally, the user starts the power tool 14 by pressing on the control button 34, and the actual drilling operation begins, during which the tool 12, embodied as a drill, penetrates into the workpiece 16. The measurement unit 10 constantly detects the distance D in the process. Once the distance D reaches the negative, settable value of the set-point penetration depth Dₛ, the signal unit 22 trips a signal that activates a shutoff mechanism 24, which causes an interruption in a supply current of the power tool 14 and as a result, as a function of the distance D detected by the measurement unit 10, switches off the power tool 14.

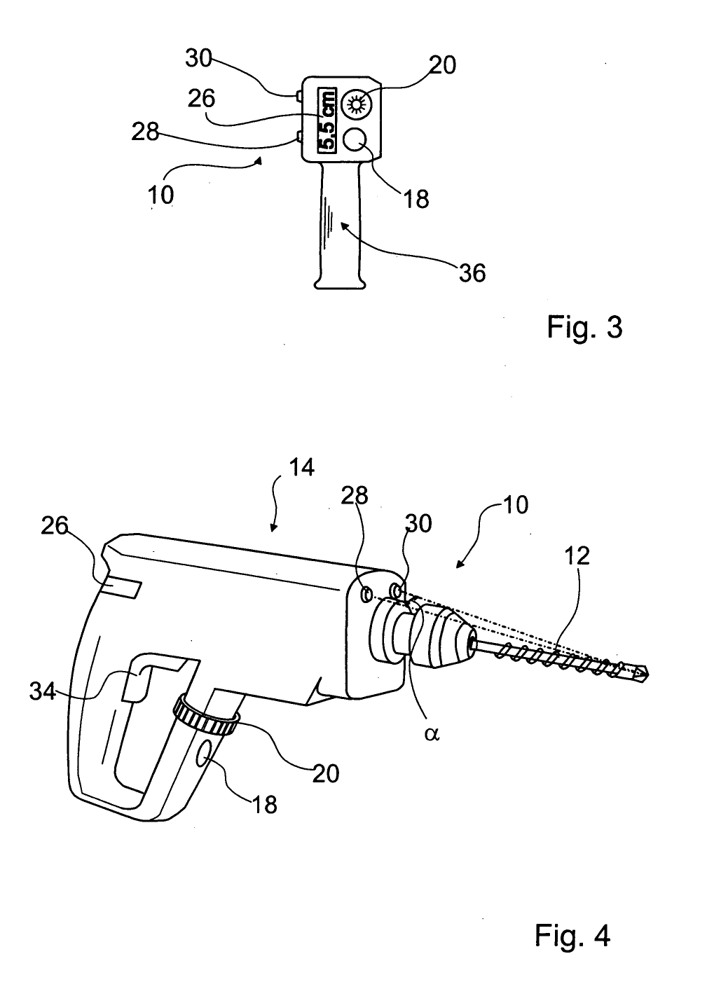

Further exemplary embodiments of the invention are shown in FIGS. 2 through 4. The description of these exemplary embodiments will be limited to differences from the exemplary embodiment shown in FIG. 1. With a view to characteristics that remain the same, reference may be had to the description of the exemplary embodiment shown in FIG. 1. Analogous characteristics in the various exemplary embodiments are identified by the same reference numerals.

In FIG. 2, a penetration-depth-determining device is shown that is integrated into a detachable handle 36 of a power tool 14 designed as a power drill. The handle 36 is braced against the power tool 14 in a front region of the power tool and has a display unit 26, embodied as a liquid crystal display, which is intended for displaying a variable that is dependent on a distance D detected by a measurement unit 10 of the penetration-depth-determining device. An arithmetic unit, not explicitly shown here, of the penetration-depth-determining device determines this variable as a difference between a zero point of the distance measurement and the detected distance D.

The zero point of the distance measurement can be adjusted by a user at any time, by pressing on a means 18 embodied as a button, to a distance D currently being detected by the measurement unit 10. The variable indicates a current penetration depth. In this exemplary embodiment, an automatic shutoff of the power tool 14 can advantageously be dispensed with, since the user receives feedback about the current penetration depth at all times from the display unit 26.

FIG. 4 shows a further exemplary embodiment of the invention, in which a means 18 for adjusting and means 20 for setting a set-point penetration depth Dₛ are integrated into a handle of a power tool 14. The means 20 is embodied as a ring fitting around the handle, and this ring can be turned in the circumferential direction by a user to set the set-point penetration depth Dₛ. On a back side of the power tool 14, facing toward the user during operation, there is a display unit 26, which displays a current penetration depth.

1. A penetration-depth-determining device, having a measurement unit (10), for determining a penetration depth of a tool (12) of a power tool (14) into a workpiece (16), characterized in that the measurement unit (10) is intended for contactless measurement of a distance (D) from the workpiece (16).

2. The penetration-depth-determining device according to claim 1, characterized by a means (18) for adjusting the measurement unit (10).

3. The penetration-depth-determining device according to claim 1, characterized by a means (20) for setting a set-point penetration depth (Dₛ).

4. The penetration-depth-determining device according to claim 3, characterized in that the means (20) includes a rotary knob.

5. The penetration-depth-determining device according to claim 1, characterized in that a signal unit (22) is intended for tripping a signal when the distance (D) attains a settable value.

6. The penetration-depth-determining device according to claim 1, characterized by a shutoff mechanism (24) for switching off the power tool (14) as a function of the distance (D) detected by the measurement unit (10).

7. The penetration-depth-determining device according to claim 1, characterized by a display unit (26), which is intended for displaying a variable that is dependent on the detected distance (D).

8. The penetration-depth-determining device according to claim 1, characterized in that the measurement unit (10) is embodied as an optical measurement unit.

9. The penetration-depth-determining device according to claim 1, characterized in that the measurement unit (10) is intended for detecting a reflection angle (α).

10. The penetration-depth-determining device according to claim 1, characterized in that the measurement unit (10) is embodied as a light scanner.

11. The penetration-depth-determining device according to claim 1, characterized in that the measurement unit (10) is integrated with a handle (36) of the power tool (14).

12. A power tool (14) having a penetration-depth-determining device defined by claim 1.
